(19) United States
(12) Patent Application Publication
(10) Pub. No.: US 2002/0179610 A1
(43) Pub. Date: Dec. 5, 2002

(54) Pressurized sandwich skin for cryogenic propellant tanks

(75) Inventors: Walter Fraklin III, Canyon Country, CA (US); David A. Hooke, Palmdale, CA (US)

Correspondence Address: Robert A. Schruhl, 1011 Lockheed Way, Palmdale, CA, 93599-2191, US

(73) Assignee: Lockheed Martin Corporation

(21) Appl. No.: 09/872,208

(22) Filed: Jun. 4, 2001

(51) Int. Cl. F17C 1/00; F17C 3/00

(52) U.S. Cl. 220/560.1

(57) ABSTRACT

A wall of a cryogenic propellant tank includes inner and outer skins supported parallel to, and at a distance from, one another to define between them a zone into which pressurized gas is introduced. The zone houses a reinforcing structure, such as honeycomb or corrugated material, to create a sandwich structure. The gas is introduced into the zone using conduits in the reinforcing structure. The gas preferably is an inert gas, most preferably helium.

### BACKGROUND OF THE INVENTION

1. Field of the Invention

The present invention relates to wall constructions for tanks and the like designed to contain cryogenic propellants, and more particularly to a novel wall construction in which a pressurized gas is pumped into and maintained in the core of a composite tank wall to create a leak-proof barrier for the cryogenic material contained within the tank, as well as to provide an inert atmosphere to substantially reduce or eliminate the risk of explosion.

2. Description of the Related Art

The use of a foam, honeycomb fiber, or ceramic materials for the core of complex structure walls for cryogenic tanks, especially for tanks designed for containment of cryogenic fuels and other related highly explosive materials, is well known in the prior art. Typically, such tank walls include an inner skin which is disposed in contact with the cryogenic materials, an outer skin which is disposed in relation to the inner skin in such a manner as to be exposed to the ambient or another structural component, and a core structure which typically comprises a solid, foamed, or fibrous material, chosen for the most part for its thermal insulating and structural properties.

One of the more serious problems encountered in tanks containing cryogenic fluids (in either liquid or gaseous forms) is the tendency for the cryogenic material in the tank to leak through the tank wall. This leakage occurs as a result of the pressure under which the cryogenic fluids are typically stored, and is exacerbated by the small molecular size of some cryogenic fluids, such as hydrogen and helium.

Recent aerospace vehicle design trends have highlighted the use of advanced composite materials for cryogenic tanks in an effort to reduce weight. However, the walls of cryogenic tanks fabricated from polymer matrix composite materials are prone to micro cracking at cryogenic temperatures under the combined action of thermal and mechanical strain, with a resulting increase of the leakage of the cryogenic fluid through the tank wall. Not only does this situation result in loss of the cryogenic material from the tank, but it also creates an unsafe environment due to the volatility of many of the cryogenic fluids. An added risk is that any cryogenic fluids that escape the tank and become trapped in a confined volume can cause significant damage as the cryogenic fluid warms and expands.

U.S. Pat. No. 4,925,134 to Keller et al discloses a high temperature heat shield for re-entry vehicles and high-speed aircraft. The heat shield preferably comprises a first layered element including inner and outer metal sheets disposed on opposite sides of a metal foil sandwich core, a second layered element including a stack of corrugated metal foil layers disposed on opposing sides of a ceramic fiber layer having a specific thermal insulating value, and a third layered element similar to the first layered element.

Further, U.S. Pat. No. 6,082,676 to Cochran discloses a cryogenic tank for launch vehicles and teaches the formation of a dry ice block in a forming chamber having porous wall through which gaseous carbon dioxide passes to escape into the surrounding atmosphere while the carbon dioxide condenses into carbon dioxide snow. This differs from the present invention inasmuch as the gaseous carbon dioxide is not being retained within the tank wall under pressure wall so as to prevent escape of the cryogenic material held within the tank, and further provides no thermal insulating properties.

Against this background of known similar technology, the applicant has developed a novel tank wall construction which includes an inner skin, an outer solid skin disposed substantially parallel to the inner skin and defining therewith a core, and a structural element sandwiched between the inner and outer skins for giving structural support to the wall construction, and within which is pumped a gas, preferably helium, at a pressure which matches the pressure of the cryogenic gas contained within the tank.

### OBJECTS AND SUMMARY OF THE INVENTION

It is therefore an object of the present invention to provide a novel wall construction for use in tanks designed for containment of cryogenic materials, while overcoming all of the shortcomings and disadvantages of previously known and similar tank wall structures.

Another object of the present invention is to provide a novel method and wall construction for cryogenic tanks to prevent escape of the cryogenic substance from within a tank. A tank wall structure is provided that introduces a pressurized gas into the wall structure in such a manner that the pressure of the gas within the wall structure matches the pressure within the tank, or is slightly greater than the pressure in the tank. In effect, this pressurized gas would then function as a barrier or seal to prevent the leakage of cryogenic fluid through the tank inner wall.

Other objects, advantages and features of the invention will become more apparent, as will equivalent structures, which are intended to be covered herein, with the teaching of the principles of the invention in connection with the disclosure of the preferred embodiments thereof in the specification, claims and drawings in which:

### BRIEF DESCRIPTION OF THE DRAWINGS

FIG. 1 depicts a fuel tank or the like in which a cryogenic substance, such as a propellant, is to be contained, and

FIG. 2 is a schematic sectional representation of a portion of the wall of the tank shown in FIG. 1.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a novel construction and method for preventing leakage of pressurized cryogenic substances from within a tank that also provides an inert atmosphere surrounding the cryogenic substance thereby eliminating the risk of explosion.

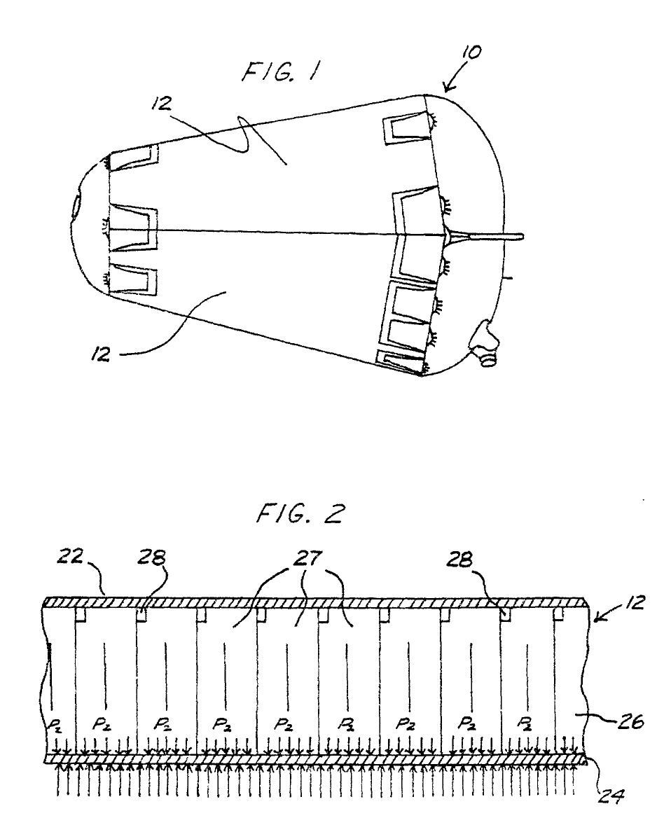

Referring now to the FIG. 1 of the drawing, a tank 10 of the type typically carried by aerospace vehicles, and having walls defining an enclosure in which cryogenic materials, for example cryogenic propellants such as liquid hydrogen or liquid oxygen, are stored.

Referring now to FIG. 2, there is shown a cross-sectional schematic representation of a section of the tank wall shown at 10 in FIG. 1. The tank wall comprises an outer skin 22, an inner skin 24, and sandwich reinforcing structure 26 disposed between the inner and outer skins, and forming cells or compartments 27 with the inner and outer skins. The cryogenic material contained within the tank is generally maintained at a pressure, P₁. Conduits 28 are formed in the sandwich reinforcing core structure 26 for the purpose of facilitating the introduction of a gas into the compartments 27. The gas is pumped through conduits 28 into the compartments 27 and maintained therein under pressure P₂. Preferably, the gas is one, which does not liquefy when subjected to the temperature of such cryogenic materials as liquid oxygen or liquid hydrogen. Preferably, the gas is one that serves as an inert atmosphere to eliminate the risk of explosion if the gas in the tank were to leak or permeate out through the inner skin of the sandwich reinforcing core structure. Most preferably, the gas pumped into the compartments is helium. Pressurizing the sandwich reinforcing core structure 26 prevents leakage through the inner skin 24. The cryogenic material contained in tank 10 is typically maintained at a pressure P₁ substantially equal to the pressure P₂ of gas introduced into the core material.

Those skilled in the art will appreciate that various adoptions and modifications of the invention as described above can be configured without departing from the scope and spirit of the invention. Therefore, it is to be understood that, within the scope of the appended claims, the invention may be practiced other than as specifically described herein.

What I claim is:

1. Wall structure for a cryogenic propellant tank, comprising:
inner and outer tank wall skins supported at a distance from one another to define therebetween a zone, and
means for introducing a pressurized gas into the zone between said inner and outer skins.

2. The wall structure of claim 1, and further including reinforcing means disposed between said first and second skins in said zone.

3. The wall structure of claim 2, wherein said means for introducing said pressurized gas into the zone comprises conduits associated with said reinforcing means, and said gas comprises an inert gas.

4. The wall structure of claim 3, wherein said gas comprises helium.

5. The wall structure of claim 3, wherein said reinforcing means comprises sandwich structure, and said conduits are disposed in said sandwich structure.

6. The wall structure of claim 3, wherein the pressure of the cryogenic material inside the tank is equal to the pressure of the gas introduced into the zone.

7. A method of preventing leakage of a first pressurized gas from within a storage tank, comprising:
establishing a structural zone about said tank,
introducing a second gas into said structural zone, and
maintaining said second gas at a pressure substantially equal to the pressure of the first gas within said tank.

8. The method of claim 7, wherein said first pressurized gas is a cryogenic material.

9. The method of claim 8, wherein said second pressurized gas is helium.
